(19) United States
(12) Patent Application Publication
(10) Pub. No.: US 2002/0080171 A1
(43) Pub. Date: Jun. 27, 2002

(54) Method and apparatus for coordinating screen views in a collaborative computing environment

(76) Inventors: Robert James Laferriere, Wauwatosa, WI (US); Francis William Kasper, Mllwaukee, WI (US)

Correspondence Address: Patrick S. Yoder, Suite 330, 7915 FM 1960 West, Houston, TX, 77070, US

(21) Appl. No.: 09/746,953

(22) Filed: Dec. 22, 2000

(51) Int. Cl. G06F 13/00

(52) U.S. Cl. 345/751; 345/733

(57) ABSTRACT

A technique for controlling a computer in a collaborative environment is provided. The controlled computer runs a program that generates a user interface screen. The screen is captured and transmitted to the controlling computer. The controlling computer originates input events that are transmitted to the controlled computer and interpreted in accordance with the program. Logical portions of the screen are identified based upon the input events and the program, and are cached at the controlling computer to speed display of changes in the screen and the reduce bandwidth load.

### FIELD OF THE INVENTION

The present invention relates generally to the field of collaborative computing systems and environments. More particularly, the invention relates to a technique for sharing views on screens between a controlled computer and a controlling computer in a collaborative environment wherein an application producing screen views runs on a controlled computer.

### BACKGROUND OF THE INVENTION

A range of computer applications and techniques are known and used for receiving and displaying screens, typically employed as graphical user interfaces. In conventional web browsers, for example, screens are defined by code which is tagged to represent such features as placement, color, text, fonts, and so forth. Additional tags may refer to links for graphical items, such as pictures and icons. When a user accesses a page, an application, which is typically running at the user's computer, sends commands which are interpreted by a communicating computer to transmit the code which defines the screens. Where applications are running locally on the user's computer, such as word processing applications, spreadsheet applications, and any other applications employing a user interface, the application code itself generally defines the user interface screens, including the text or images displayed, interface tools, such as buttons and menus, and so forth.

Applications running on a user's computer or workstation are generally adapted to track input events, such as mouse clicks and keyboard inputs, to process or manipulate the application data and commands in accordance with the user's desires. Thus, where a graphical user interface screen includes a virtual button at a defined location, a click on the virtual button creates a command which can be interpreted by the application in accordance with the code defining the screen, in this particular example, the button on which the user clicked. Wide range of such graphical user interfaces have been developed and are currently in use for controlling an application at a local workstation or for controlling an interface and an application where the interface and the application are at different locations.

In a collaborative computing environment, an application is run by a first computer, and a second computer monitors the interface events occurring at the first computer. Such collaborative environments are used in a number of settings, such as for training purposes, trouble shooting purposes, and so forth. In general, it is often useful for the first computer to be a controlled computer, with a second or remote computer being a controlling computer. The controlling computer can then become the source of commands for the application run by the controlled computer. For example, in a training environment, a trainer or an expert can demonstrate the use of certain features of an application by originating command inputs at the controlling computer, while the application itself is run on the controlled computer. The user at the controlled computer, typically a person needing training, is allowed to view the screens resulting from the controlling computer inputs on the controlled computer. Where desired, the user at the controlled computer may also originate inputs which can be tracked by the trainer on the controlling computer. Similar modes of utilization are common in trouble shooting situations where a technician or expert may need to take control of a user or client's workstation to evaluate troubles or abnormalities experienced by the user.

The location at which an application runs in a collaborative environment may aide in determining the best solution for exchanging interface screens. For example, in a gaming environment, ghosting techniques are commonly employed based upon anticipation of changes in an application, where the application is actually run by all computers cooperating in a real or near real time game. Quite distinct from these situations, collaborative environments typically allow a single computer to run an application, with one or more computers simply monitoring the interface screens produced by the application, and, where desired, originating inputs for the application run by the controlled computer. It should be noted, that while reference is made herein to an application running on a controlled computer, in reality, such applications may be resident on and executed wholly or partially by a processor physically located at the controlled computer or remote from the controlled computer. However, the application is typically not running at the controlling computer.

A challenge that arises in collaborative environments involves the rapid and efficient transmission of screen display information produced by an application run by a controlled computer. Because the controlling computer is not directly interfacing with the application, the screen, or a portion of the screen, displayed on the controlled computer is typically captured and transmitted to the controlling computer to coordinate the views and to allow the controlling computer user to accurately interface with the application. Where such screens include a large amount of data, however, repetitive screen captures of this type can require significant amounts of bandwidth. While this may be acceptable if the available bandwidth is sufficiently wide, or where the amount of data needed can be reduced otherwise, it can lead to significant reduction in performance where bandwidth is more limited and the data defining the screens is relatively voluminous.

There is a need, therefore, for an improved technique for communicating screen data between controlled and controlling computers in a collaborative computing environment. There is a particular need, at present, for a technique which can permit rapid updating of screens on a controlling computer were bandwidth is fairly limited as compared to the amount of data defining the interface screens.

### SUMMARY OF THE INVENTION

The present invention provides a screen view coordinating technique designed to respond to such needs. The technique may be employed in a wide range of settings, but is particularly well suited to use with controlling computers remote from controlled computers, such as in training and trouble shooting situations. Moreover, the technique may be used with any suitable application, or with a number of applications operating at once by a controlled computer, where the applications are either resident at and running on the controlled computer, or accessible by the controlled computer as in networked computing arrangements. While the technique is quite well suited to situations in which a single controlling computer is coupled to a controlled computer, it may be used equally well in situations involving multiple computers, such as multiple input stations with a single controlled computer generating the display screens.

The technique makes use of a novel caching approach wherein selected logical blocks of a graphical user interface screen are identified and designated by a controlled computer, and corresponding screen data is cached by both the controlled and controlling computers. The cached data is then employed by the controlling computer to rapidly display the designated blocks, such as to move windows on both screens, iconify applications, manipulate virtual input devices such as buttons, and so forth. As input events are generated at the controlling computer and conveyed to the controlled computer, then, various portions of the screen will be identified and cached until all of the useful blocks selected by such input events at the controlling computer have been effectively cached. Background information can be transmitted, as desired, to complete the data available at the controlling computer for display, such as when windows are displaced. Thus, the amount of data transferred between the controlling and controlled computers to define the screens to be displayed on the controlling computer is significantly reduced, with input event data being transmitted to the controlled computer and some screen-defining data and cache designation data being transmitted by the controlled computer back to the controlling computer in response to such events.

In a collaborative environment, the technique may allow for multiple computers to receive data representative of the input events, and more particularly, of the screen displays and blocks for appropriate caching. Thus, one or more computers may serve as controlling computers, with the controlled computer generating the resulting screens based upon input events at one or more of the controlling computers as well as at the controlled computer.

### BRIEF DESCRIPTION OF THE DRAWINGS

FIG. 1 is a diagrammatical representation of two computer workstations coupled in a collaborative environment and employing aspects of the present technique;

FIG. 2 is a simplified diagrammatical representation of the system illustrated in FIG. 1, wherein an iconification command is input at the controlling computer;

FIG. 3 is a diagrammatical representation similar to that of FIG. 2, wherein a window move command is input by the controlling computer;

FIG. 4 is a flow chart illustrating exemplary control logic in executing the caching and data transmission operations of the present technique;

FIG. 5 is a diagrammatical representation of a collaborative environment similar to that illustrated in the previous figures, but in which two controlling computers are coupled to a controlled computer over a network; and

FIG. 6 is a diagrammatical representation of an exemplary implementation of the present technique in a medical diagnostic application wherein a controlled computer is coupled directly to a medical diagnostic imaging system and the technique is employed for a training or trouble shooting purposes.

### DETAILED DESCRIPTION OF THE INVENTION

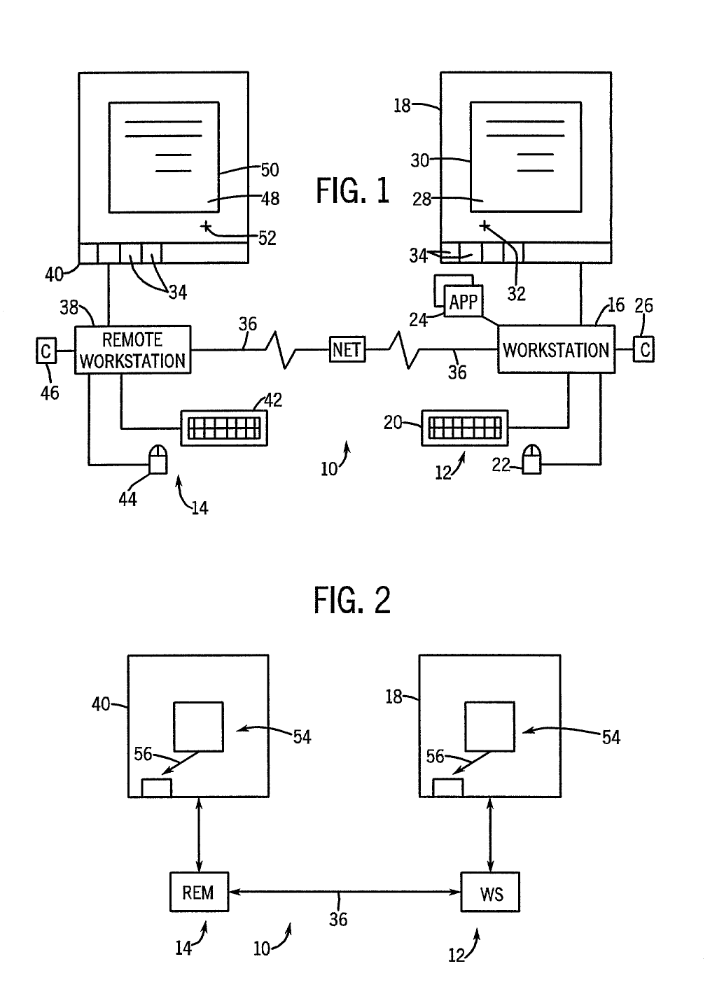

Referring now to FIG. 1, a system 10 is illustrated for providing display screens used in controlling one computer system via another computer system. In the illustrated system, a controlled computer system 12 is linked to a controlling computer system 14. The controlled and controlling computer systems may include any suitable computers employing various hardware, firmware and software platforms. In a presently contemplated embodiment, for example, the computer systems include workstations that operate on a UNIX platform. However, any other suitable platform may employed, including Solaris, IRIX, LINUX and so forth.

The controlled computer system 12 thus includes a workstation 16, one or more monitors 18, and various input devices, such as a conventional keyboard 20 and mouse 22. An operating system and software applications running on the controlled computer system 12, such as via one or more CPUs of workstation 16, are thus interfaced via the input devices and the monitor. Such applications, designated generally by reference numeral 24 in FIG. 1, may include any suitable application, such as machine or system control applications, data processing applications, spreadsheets, data exchange applications, image viewing applications, browsers, and so forth. The applications will produce one or more display screens viewable on monitor 18 and which are conveyed to the controlling computer system 14 as described below. It should be noted that the applications 24 which are run by the controlled computer system 12 may, in practice, be a resident on and accessed from memory directly at the workstation, or may be provided at locations remote to the workstation, such as on local or wide area networks. Similarly, the processing performed to generate the user interface screens and to manipulate such screens based upon user inputs may be performed within workstation 16 or within various other processing circuitry linked to the workstation. In general, however, where reference is made herein to applications running on or by the controlled computer system, any suitable combination of storage and processing may be implemented whereby an operator at the controlled computer system would normally manipulate the program via the input devices 20 and 22 and by reference to the user interface screens displayed on monitor 18.

In addition to any desired read-only memory, random access memory, optical memory, or any other suitable memory on workstation 16, system 12 includes cache memory 26 for storing data descriptive of screens displayed on monitor 18. Such screen displays 28 may generally include any type of user interface indicia, typically text, images, icons, and so forth. In a typical graphical user interface display, for example, one or more windows 30 will be viewable to frame portions of the screen which are logically associated with one another, such as windows generated by specific applications or functions of applications. Monitor 28 will also display a user input cursor 32 which may take any conventional form, and which may be moved about the screen display via one of the input devices 20 or 22. It should be noted that the input devices may include other types of tools, such as digitizers, probes, touch-sensitive screens or displays, and so forth. In the embodiment illustrated in FIG. 1, the screen also includes iconified displays 34, which may be aligned along a border of the display screen to indicate to the user that one or more applications is still active.

Controlled computer 12 is linked to controlling computer 14 via a network connection 36. While any suitable network connection may be employed, presently contemplated connections include local area networks, wide area networks, the Internet, virtual private networks, and so forth. Moreover, any suitable medium or media may be employed for the network connection, including cable, dedicated connections, wireless connections, or any combination of these or other media.

The controlling computer system 14 includes a workstation 38, a monitor 40, and input devices 42 and 44. As noted above, any suitable computer system may be employed as the controlling computer system, and the latter need not be identical or even similar to the controlled computer system. The controlling computer system 14 includes various memory, but preferably includes cache memory 46 for storing portions of the display screen as described below. The present technique permits screens to be displayed on monitor 40 which are substantially the same as screens displayed on monitor 18 such that the controlling computer system 14 can originate inputs and track changes in the display on monitor 18 of the controlled computer system so as to regulate operation of the controlled computer system via the applications run by the latter. Thus, the screen display 48 provided on monitor 40 will be derived from that viewable on monitor 18, and will typically include the same windows 50 in the same locations and the same indicia displayed in such windows. A cursor 52 is displayed on monitor 40 of the controlling workstation, but is completely independently controllable with respect to the cursor 32 on the controlled computer system.

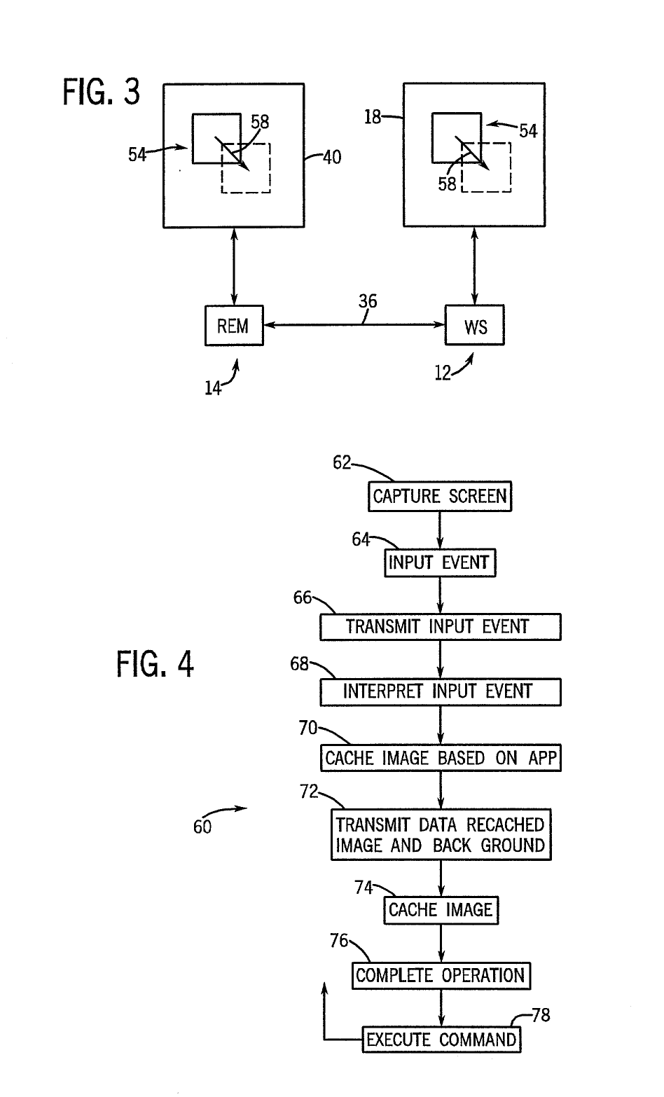

FIGS. 2 and 3 illustrate exemplary operations which serve as the basis for the present discussion of control implemented between the computer systems. As noted above, applications are run by the controlled computer system 12, but can be manipulated via the controlling computer system 14. In the example illustrated diagrammatically in FIG. 2, a display 54 is provided on both computer systems, with the display being originally generated by the applications run by the controlled computer system. In this example, the application window of the display is iconified or reduced to an icon as illustrated by arrows 56. In the second exemplary operation shown in FIG. 3 the display 54 is displaced from one location on the screen to another as indicated by arrows 58. In general, the nature of the operation is to provide the same display screen on the controlling computer system as that generated by the applications run by the controlled computer system. Inputs made by the operator on the controlling computer system, then, are transmitted to the controlled computer system where they are interpreted and implemented in accordance with the application. Where the input results in a change in the screen displayed on the controlled computer system, information regarding the change, including data for display on both systems, is transmitted back to the controlling computer system to appropriately change its display. Portions of the display screen which are logically grouped in accordance with the applications run by the controlled computer system are then progressively cached to facilitate changes in the screens, and to significantly reduce the volumes of data which are transmitted between the systems during the course of collaborative work.

FIG. 4 represents exemplary control logic for carrying out the screen display and caching operations in accordance with aspects of the present technique. The control logic, designated generally by reference numeral 60, begins with a screen capture as indicated at step 62. As noted above, the screen displayed on the controlled computer system will typically be generated by one or more applications run by that computer system. At step 62, then, the screen is simply captured at the controlled computer system and data defining the screen is transmitted to the controlling computer system via the network. At this point, both computer systems display similar screens, and the operator at the controlling computer system may manipulate the location of a cursor 52 (See, FIG. 1) or may enter any desired input based upon this cursor position or any other allowed parameter of the input devices.

Upon occurrence of an input event, such as a mouse click at a desired cursor position, or depressing one or more keys on a keyboard, an input event is logged as indicated at step 64 in FIG. 4. As will be appreciated by those skilled in the art, such input events are encoded in accordance with the particular input devices employed. Signals resulting from encoding of the input event at step 64 are transmitted at step 66 from the controlling computer system to the controlled computer system via the network. At step 68 the input event is interpreted at the controlled computer system. In general, such interpretation will be based not only on the nature and type of input even, but upon the location of cursor 52 on the controlling computer system at the time of the input event, or similar data, and upon the meaning of that event in the applications running on the controlled computer system. In other words, the input event originating in the controlling computer system is interpreted by the controlled computer system as if the input event had occurred at the controlled computer system. Such interpretation will result in definition of one or more designated portions of the display present on the controlled computer system monitor. Such portions may include graphical input devices, such as virtual buttons, windows, screen frames, display areas, specific images, specific text, and so forth. The corresponding portion of the screen as defined by the particular application generating the logical portion is then cached in memory as indicated at step 70 in FIG. 4. Again, the caching performed at step 70 will result in storage of a portion of the screen in cache memory 26 (See, FIG. 1).

At step 72, data indicative of the portion of the image cached at step 70 is transmitted from the controlled computer system to the controlling computer system. In a simple example, the data transmitted at step 72 may simply include coordinates, limits, or similar boundaries of a portion of the screen to be logically grouped and cached. In a graphical user interface, for example, such boundaries may be defined by frames of an application window, limits or boundaries around graphical input device or virtual button, and so forth. With the data defining the cached portion of the screen received by the controlling computer system 14, the identical portion of the screen is then cached by the controlling computer system as indicated at step 74.

It should be noted that where certain types of screen portions are cached at step 74, data descriptive of other screen portions may be transmitted to permit completing of the desired operation. For example, where operations such as those illustrated in FIGS. 2 and 3 are to be performed, the controlling computer system will not originally include data defining background used to fill areas which will be vacated by the iconified or displaced window. Thus, at step 72 this background data may also be transmitted to permit filling of the background upon execution of the operation.

At step 76 the requested operation is completed, including the iconification of FIG. 2, the move of FIG. 3, or any other desired change in the screen display resulting from the code of the applications running on the controlled computer system. At step 78 the actual command corresponding to the input event generated at the controlling computer system is executed by the applications of the controlled computer system. Subsequent input events can then be made and processed by returning to step 64 in FIG. 4.

As will be appreciated by those skilled in the art, the foregoing procedure permits the controlling computer system to display and cache screen portions as if the applications were being run by the controlling computer system, thereby allowing control of the applications run on the controlled computer system. The technique is particularly well-suited to collaborative computing environments in which the controlling computer is used to provide training or troubleshooting for the operator at the controlled computer. As described below, the technique may be employed with a plurality of controlling computers, so as to provide similar functionality at multiple locations. Moreover, the technique may be applied in applications where the controlled computer is coupled to a machine system, such as for actual control of the system. In such situations, the controlling computer may serve as an interface for remote servicing, troubleshooting, an so forth.

As will be appreciated by those skilled in the art, any suitable programming code and platform may be employed in the present technique. In a present implementation, a UNIX-based platform is employed in which events are posted as X-server commands. Other operating system platforms have similar event publication mechanisms. In the UNIX-based platform, event publication commands may generally be provided in an X-test module on the X-server. Also in the present implementation, the controlled computer monitors for inputs on its own input devices. The technique makes use of a server application which is sent to the client (i.e., the controlled computer) and which is capable of knowing or recognizing the frame buffer protocol and server commands. In general, then, the controlling computer simply provides indications of input events to the controlled computer, with logical portions of the screen being successively cached to improve the speed of transmission and updating of the screens, and to reduce bandwidth load.

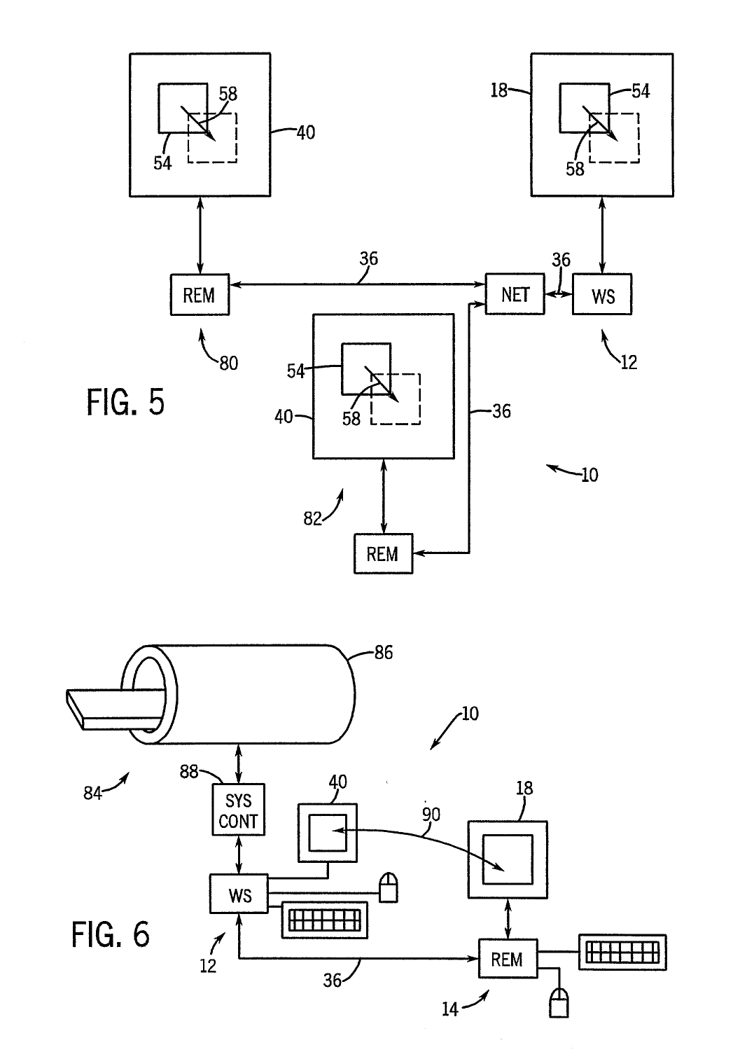

As noted above, the present technique may be employed with a plurality of computer systems. Such a scenario is illustrated diagrammatically in FIG. 5. As shown in FIG. 5, the system would include a first remote system 80 which serves as a controlling computer, and a second remote system 82 which serves as a second controlling computer. The remote systems are coupled to the controlled computer 12 via a network, such as the Internet. As before, screens provided on the controlled computer as a function of the program run by the controlled computer are captured and transmitted to both controlling computers 80 and 82 for display. Inputs from either controlling computer are conveyed to the controlled computer where they are received and interpreted in accordance with the type of input event and the program run by the controlled computer. As in the previous example, a logical portion of the screen is then identified and instructions for caching the portion of the screen are transmitted from the controlled computer back to the controlling computers. Thus, all of the computers in the system maintain similar screen views, with bandwidth load being reduced by virtue of the caching performed at both controlling computers.

As also noted above, the present technique may be employed for troubleshooting or control of an actual physical system coupled to the controlled computer. By way of example, in a medical diagnostic situation, a medical diagnostic imaging system may be accessed and parameters relating to operation of the system may be viewed and modified by the controlling computer as desired. A scenario of this type is illustrated diagrammatically in FIG. 6. As shown in FIG. 6, the controlled computer system 12 is coupled to a medical diagnostic imaging system 84, such as a magnetic resonance imaging system. As will be appreciated by those skilled in the art, such imaging systems typically include a scanning arrangement 86 designed to acquire image data based upon a pre-established protocol and examination instructions provided by a system controller 88. The controlled computer system 12 serves as an interface for the imaging system and provides for operator input of operating parameters, settings, and so forth. Where training, troubleshooting, or where appropriate, actual control of the system from a remote location is desired, controlled computer system 12 may be linked to controlling system 14 via network 36. The controlling computer system may be located, by way of example, at a service provider location and staffed by field engineers or system experts. Thus, through implementation of the foregoing technique, the screen views produced on the controlled computer system are conveyed through the controlling computer system and input events at the controlling computer system server to progressively cache portions of the screen to reduce bandwidth loads and to improve response of the system to the input events.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for commanding operations on a controlled computer via a controlling computer in a collaborative computing environment, the method comprising the steps of:
generating a screen display at a controlled computer based upon a program run by the controlled computer;
transmitting data representative of the screen display to a controlling computer;
transmitting input event data representative of an input event from the controlling computer to the controlled computer;
identifying a logical block of the screen display affected by the input event at the controlled computer based upon the program and the input event data;
transmitting data corresponding to the logical block from the controlled computer to the controlling computer; and
caching display data for at least the logical block at the controlling computer.

2. The method of claim 1, comprising the step of caching at least the data corresponding to the logical block at the controlled computer.

3. The method of claim 1, wherein the data corresponding to the logical block includes data representative of coordinates of a perimeter of the logical block.

4. The method of claim 1, wherein the program is resident at and is run on the controlled computer.

5. The method of claim 1, wherein the input event includes a signal generated on an operator input device.

6. The method of claim 5, wherein the operator input device includes a computer mouse.

7. The method of claim 1, wherein the input event data includes a screen location of an operator selected input.

8. The method of claim 1, comprising the step of executing an instruction via the controlled computer based upon the input event.

9. The method of claim 1, wherein the logical block includes a display window.

10. The method of claim 1, wherein the logical block includes a graphical command device.

11. A method for controlling operation of a controlled computer via a controlling computer in a collaborative environment, the method comprising the steps of:
displaying an interface screen at a controlled computer based upon a program run by the controlled computer;
transmitting screen data representative of the screen for display at a controlling computer coupled to the controlled computer via a network;
transmitting input event data from the controlling computer to the controlled computer via the network;
designating a portion of the screen at the controlled computer based upon the input event data and the program;
caching the portion of the screen at the controlling and controlled computers; and
executing a command based upon the input event data.

12. The method of claim 11, wherein the input event data includes data identifying a location of a graphical element on the screen.

13. The method of claim 12, wherein the portion of the screen is designated based upon functionality of the portion at the location as defined by the program.

14. The method of claim 11, wherein the portion of the screen is cached at the controlling computer by transmitting data indicative of limits of the portion from the controlled computer to the controlling computer, and capturing the portion of the screen within the limits.

15. The method of claim 11, comprising the step of transmitting from the controlled computer to the controlling computer background data representative of a portion of a screen beneath the portion.

16. The method of claim 15, wherein the command includes movement of the portion, and wherein the background data is referenced to fill a section of the screen from which the portion is moved.

17. The method of claim 11, wherein the portion includes a display window.

18. The method of claim 11, wherein the portion includes a graphical input device.

19. The method of claim 11, network includes the Internet.

20. A method for sharing control of a controlled computer via in a collaborative environment, the method comprising the steps of:
displaying an interface screen at a controlled computer based upon a program run by the controlled computer;
transmitting screen data representative of the screen for display at plurality of controlling computers coupled to the controlled computer via a network;
transmitting input event data from at least one of the controlling computers to the controlled computer via the network;
designating a portion of the screen at the controlled computer based upon the input event data and the program;
caching the portion of the screen at least at the controlling computers; and
executing a command based upon the input event data.

21. The method of claim 20, wherein the input event data includes data identifying a location of a graphical element on the screen.

22. The method of claim 20, wherein the portion of the screen is cached at the controlling computers by transmitting data indicative of limits of the portion from the controlled computer to the controlling computers, and capturing the portion of the screen within the limits.

23. The method of claim 20, comprising the step of transmitting from the controlled computer to the controlling computers background data representative of a portion of a screen beneath the portion.

24. A collaborative computing system comprising:
a controlled computer configured to run a program and to display a user interface screen based upon the program;
a controlling computer linked to the controlled computer via a network, the controlling computer receiving screen data via the network for display of the interface screen;
a cache memory coupled to the controlling computer and configured to cache portions of the interface screen identified by the controlled computer based upon input events occurring at the controlling computer and based upon the program.

25. The system of claim 24, wherein the controlling computer includes an input device and data representative of input events made via the input device are transmitted to the controlled computer via the network to permit identification of the portions of the interface screen.

26. The system of claim 24, wherein the controlled computer includes a cache memory and is configured to cache the portions of the interface screen.

27. The system of claim 24, wherein the program is resident at and runs on the controlled computer.

28. The system of claim 24, wherein the controlled computer is coupled to a controlled device, and wherein instructions corresponding to the input events are executed on the controlled device.

29. The system of claim 24, comprising a plurality of controlling computers linked to the controlled computer via the network, each controlling computer including a cache memory for storing the portions of the interface screen.
